(19) United States
(12) Patent Application Publication
(10) Pub. No.: US 2024/0136587 A1
(43) Pub. Date: Apr. 25, 2024

(54) RECHARGEABLE LITHIUM BATTERY

(71) Applicant: SAMSUNG SDI CO., LTD., Yongin-si (KR)

(72) Inventors: Hongryeol PARK, Yongin-si (KR); Hyunbong CHOI, Yongin-si (KR); Sangwoo PARK, Yongin-si (KR); Dahyun KIM, Yongin-si (KR); Sundae KIM, Yongin-si (KR); Yeji YANG, Yongin-si (KR); Sanghoon KIM, Yongin-si (KR)

(21) Appl. No.: 18/459,225

(22) Filed: Aug. 31, 2023

(30) Foreign Application Priority Data
Oct. 11, 2022 (KR) 10-2022-0129917

(51) Int. Cl. H01M 10/0569; H01M 4/36; H01M 4/38; H01M 4/505; H01M 4/525; H01M 4/583; H01M 10/052; H01M 10/0567; H01M 10/0568

(52) U.S. Cl. CPC H01M 10/0569; H01M 4/364; H01M 4/386; H01M 4/505; H01M 4/525; H01M 4/583; H01M 10/052; H01M 10/0567; H01M 10/0568; H01M 2004/027

(57) ABSTRACT

Provided is a rechargeable lithium battery including an electrolyte solution including a non-aqueous organic solvent, a first lithium salt, and an imide-based lithium salt; a positive electrode including a positive electrode active material; and a negative electrode including a negative electrode active material, wherein the non-aqueous organic solvent contains less than about 5 wt % of ethylene carbonate based on the total weight of the non-aqueous organic solvent, and the positive electrode active material includes a cobalt-free lithium nickel manganese-based oxide.

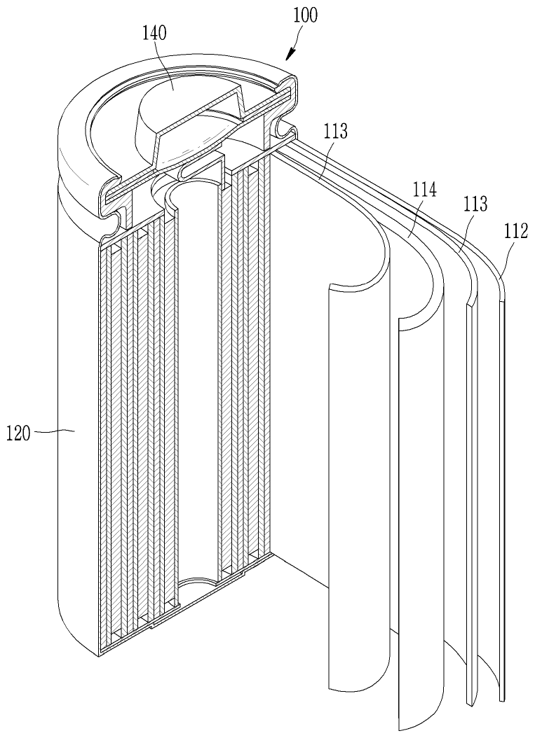

### CROSS-REFERENCE TO RELATED APPLICATION

This application claims priority to and the benefit of Korean Patent Application No. 10-2022-0129917 filed in the Korean Intellectual Property Office on Oct. 11, 2022, the entire contents of which are hereby incorporated by reference.

### BACKGROUND

### 1. Field

Embodiments of this disclosure relate to a rechargeable lithium battery.

### 2. Description of the Related Art

A rechargeable lithium battery may be recharged and has three or more times as high energy density per unit weight as a lead storage battery, nickel-cadmium battery, nickel hydrogen battery, nickel zinc battery and the like. It may be also charged at a high rate and thus, is commercially manufactured for a laptop, a cell phone, an electric tool, an electric bike, and the like, and research on improvement of additional energy density have been actively made.

As IT devices become increasingly high-performance, high-capacity batteries are required or desired, wherein the high capacity may be realized by expanding a voltage region to increase energy density, but there is a problem of oxidizing an electrolyte solution in the high-voltage region and thereby deteriorating performance of a positive electrode.

A cobalt-free lithium nickel manganese-based oxide is a positive electrode active material not including cobalt but including nickel, manganese, and/or the like as a main component in its composition, and accordingly, a positive electrode including the same may be economical and realize high energy density and thus has drawn attention as a next generation positive electrode active material.

However, when the positive electrode including the cobalt-free lithium nickel manganese-based oxide is used in a high-voltage environment, transition metals may be eluted due to structural collapse of the positive electrode, thereby causing a problem such as gas generation inside a cell, capacity reduction, and/or the like. This transition metal elution tends to be aggravated in a high-temperature environment, wherein the eluted transition metals are precipitated on the surface of a negative electrode and may cause a side reaction and thereby increase battery resistance and deteriorate battery cycle-life and output characteristics.

Accordingly, when the positive electrode including the cobalt-free lithium nickel manganese-based oxide is used, an electrolyte solution applicable under high-voltage and high-temperature conditions is required.

### SUMMARY

An embodiment of the present disclosure provides a rechargeable lithium battery exhibiting improved high-voltage characteristics and high-temperature characteristics by combining a positive electrode including cobalt-free lithium nickel manganese-based oxide together with an electrolyte solution capable of effectively protecting the positive electrode including cobalt-free lithium nickel manganese-based oxide to reduce elution of transition metals under high-voltage and high-temperature conditions and thereby to suppress or reduce structural collapse of the positive electrode.

An embodiment provides a rechargeable lithium battery including an electrolyte solution including a non-aqueous organic solvent, a first lithium salt, and an imide-based lithium salt; a positive electrode including a positive electrode active material; and a negative electrode including a negative electrode active material;
wherein the non-aqueous organic solvent contains less than about 5 wt % of ethylene carbonate based on the total weight of the non-aqueous organic solvent; and
the positive electrode active material includes a cobalt-free lithium nickel manganese-based oxide.

The imide-based lithium salt may be bis sulfonyl imide-based lithium salt.

The imide-based lithium salt may be one or more selected from Li(FSO₂)₂N (lithium bis(fluorosulfonyl)imide: LiFSI), and LiN(CₓF₂ₓ₊₁SO₂)(C_{y}F_{2y+1}SO₂), where x of the LiN(CₓF₂ₓ₊₁SO₂)(C_{y}F_{2y+1}SO₂) is an integer in a range from 1 to 20, and y of the LiN(CₓF₂ₓ₊₁SO₂)(C_{y}F_{2y+1}SO₂) is an integer in a range from 0 to 20.

The imide-based lithium salt may be represented by any one selected from Chemical Formula 1A to Chemical Formula 1D.

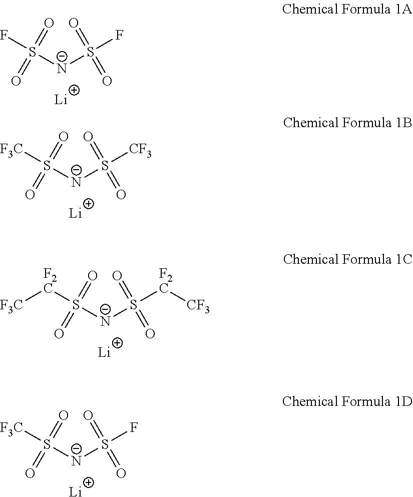

The first lithium salt and the imide-based lithium salt may be included in a molar ratio of about 1:0.1 to about 1:5.

The first lithium salt and the imide-based lithium salt may be included in a molar ratio of about 1:0.5 to about 1:2.

A content (e.g., amount) of the first lithium salt may be about 0.3 M to about 1.5 M.

A content (e.g., amount) of the imide-based lithium salt may be about 0.2 M to about 1.0 M.

The first lithium salt may be one or more selected from LiPF₆, LiBF₄, lithium difluoro(oxalato)borate (LiDFOB), LiPO₂F₂, LiSbF₆, LiAsF₆, LiC₄F₉SO₃, LiClO₄, LiAlO₂, LiAlCl₄, LiCl, LiI, and LiB(C₂O₄)₂ (lithium bis(oxalato) borate: LiBOB).

The first lithium salt may be LiPF₆.

The non-aqueous organic solvent may be composed of chain carbonate alone (e.g., may consist of chain carbonate).

The chain carbonate may be represented by Chemical Formula 2.

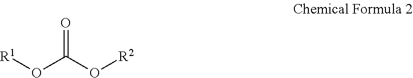

In Chemical Formula 2,
R¹ and R² may each independently be a substituted or unsubstituted C1 to C20 alkyl group.

The non-aqueous organic solvent may be a mixture of two or more solvents selected from dimethyl carbonate (DMC), diethyl carbonate (DEC), dipropyl carbonate (DPC), methylpropyl carbonate (MPC), ethylpropyl carbonate (EPC), and ethylmethyl carbonate (EMC).

The non-aqueous organic solvent may include ethylmethyl carbonate (EMC) and dimethyl carbonate (DMC) in a volume ratio of about 10:90 to about 50:50.

The electrolyte solution may further include one or more other additives selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluorobiphenyl (2-FBP).

The cobalt-free lithium nickel manganese-based oxide may include a lithium composite oxide represented by Chemical Formula 3.

LiₐNiₓMn_{y}M¹_{z}M²_{w}O_{2±b}X_{c} Chemical Formula 3

In Chemical Formula 3,
0.5≤a<1.8, 0≤b≤0.1, 0≤c≤0.1, 0≤w<0.1, 0.6≤x<1.0, 0<y<0.4, 0<z<0.1, w+x+y+z=1,
M¹ and M² may each independently be one or more elements selected from Al, Mg, Ti, Zr, Cr, Sr, V, B, W, Mo, Nb, Si, Ba, Ca, Ce, Cr, Fe, and Nb, and X is one or more elements selected from S, F, P, and Cl.

The lithium composite oxide represented by Chemical Formula 3 may be represented by Chemical Formula 3-1.

LiₐNiₓ₁Mn_{y1}Al_{z1}M²_{w1}O_{2±b}X_{c} Chemical Formula 3-1

In Chemical Formula 3-1,
0.5≤a<1.8, 0≤b≤0.1, 0≤c≤0.1, 0≤w1<0.1, 0.6≤x1<1.0, 0<y1<0.4, 0<z1<0.1, w1+x1+y1+z1=1,
M² may be one or more elements selected from Mg, Ti, Zr, Cr, Sr, V, B, W, Mo, Nb, Si, Ba, Ca, Ce, Cr, Fe, and Nb, and X is one or more element selected from S, F, P, and Cl.

In Chemical Formula 3-1, x1 may be 0.6≤x1≤0.79, y1 may be 0.2≤y1≤0.39, and z1 may be 0.01≤z1<0.1.

The negative electrode active material may include graphite, a Si composite or a mixture thereof.

The rechargeable lithium battery may have a charging upper limit voltage of greater than or equal to about 4.45 V.

An embodiment may realize a rechargeable lithium battery exhibiting improved battery stability and cycle-life characteristics by combining a positive electrode including cobalt-free lithium nickel manganese-based oxide together with an electrolyte solution capable of effectively protecting the positive electrode to secure phase transition safety of the positive electrode in a high-temperature high-voltage environment and to suppress or reduce decomposition of the electrolyte solution and a side reaction with electrodes and thereby reduce gas generation and concurrently, suppress or reduce an increase in internal battery resistance.

### BRIEF DESCRIPTION OF THE DRAWING

The accompanying drawing, together with the specification, illustrates embodiments of the subject matter of the present disclosure, and, together with the description, serves to explain principles of embodiments of the subject matter of the present disclosure.

The accompanying drawing is a schematic view illustrating a rechargeable lithium battery according to an embodiment of the present disclosure.

### DETAILED DESCRIPTION

Hereinafter, a rechargeable lithium battery according to an embodiment of the present disclosure will be described in more detail with reference to the accompanying drawing. However, these embodiments are examples, the present disclosure is not limited thereto and the present disclosure is defined by the scope of the appended claims, and equivalents thereof.

In the present specification, unless otherwise defined, “substituted” refers to replacement of at least one hydrogen in a substituent or compound by deuterium, a halogen group, a hydroxyl group, an amino group, a substituted or unsubstituted C1 to C30 amine group, a nitro group, a substituted or unsubstituted C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

In one example of the present disclosure, “substituted” refers to replacement of at least one hydrogen in a substituent or compound by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In addition, in examples of the present disclosure, “substituted” refers to replacement of at least one hydrogen of a substituent or a compound by deuterium, a halogen group, a C1 to C20 alkyl group, a C6 to C30 aryl group, a C1 to C10 fluoroalkyl group, or a cyano group. In addition, in examples of the present disclosure, “substituted” refers to replacement of at least one hydrogen of a substituent or a compound by deuterium, a halogen, a C1 to C5 alkyl group, a C6 to C18 aryl group, a C1 to C5 fluoroalkyl group, or a cyano group. In addition, in examples of the present disclosure, “substituted” refers to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

Rechargeable lithium batteries may be classified as lithium ion batteries, lithium ion polymer batteries, and lithium polymer batteries according to the presence of a separator and the type (or kind) of electrolyte solution used therein. Rechargeable lithium batteries may be classified into cylindrical, prismatic, coin-type, pouch-type, and the like according to shape, and may be divided into bulk type (or kind) and thin film type (or kind) according to the size. Structures and manufacturing methods for rechargeable lithium battery pertaining to this disclosure should be readily recognizable to a person having ordinary skill in the art after reviewing this disclosure.

Herein, as an example of a rechargeable lithium battery, a cylindrical rechargeable lithium battery is for example described. The accompanying drawing schematically shows the structure of a rechargeable lithium battery according to an embodiment. Referring to the accompanying drawing, a rechargeable lithium battery 100 according to an embodiment includes a battery cell including a positive electrode 114, a negative electrode 112 facing to the positive electrode 114, a separator 113 between the positive electrode 114 and the negative electrode 112, and an electrolyte solution (not shown) impregnating the positive electrode 114, the negative electrode 112 and the separator 113, a battery container 120 housing the battery cell, and a sealing member 140 for sealing the battery container 120.

Hereinafter, a more detailed configuration of the rechargeable lithium battery 100 according to an embodiment is described.

A rechargeable lithium battery according to an embodiment includes an electrolyte solution, positive electrode, and negative electrode.

The electrolyte solution includes a non-aqueous organic solvent, a first lithium salt, and an imide-based lithium salt, and
the non-aqueous organic solvent may include less than about 5 wt % of ethylene carbonate based on the total weight of the non-aqueous organic solvent.

The positive electrode may include a positive electrode active material including a cobalt-free lithium nickel manganese-based oxide.

The positive electrode active material including the cobalt-free lithium nickel manganese-based oxide has strong structural instability under high-voltage conditions and exhibits decomposition of the solvent and elution of transition metals and, for example, Ni.

This elution of transition metals deteriorates cycle-life of the battery due to degradation of performance of a positive electrode and generation of a short-circuit, thereby causing a resistance surge phenomenon.

However, the aforementioned electrolyte solution in which the non-aqueous organic solvent, the first lithium salt, and the imide-based lithium salt are combined together may alleviate a decrease in cycle-life and capacity and a rapid increase in resistance of the battery.

In some embodiments, when the imide-based lithium salt is combined (e.g., used together with a first lithium salt), gas generation, capacity deterioration, and resistance increase during the high-temperature storage may be further suppressed or reduced.

The positive electrode including the cobalt-free lithium nickel manganese-based oxide may be used in an electrolyte solution including the imide-based lithium salt together with the first lithium salt and less than about 5 wt % of ethylene carbonate to effectively reduce elution of transition metals under high-voltage and high-temperature conditions and thereby suppress or reduce structural collapse, thereby improving high-voltage characteristics and high-temperature characteristics of the rechargeable lithium battery.

The first lithium salt dissolved in the non-aqueous organic solvent supplies lithium ions in a battery, enables a basic operation of a rechargeable lithium battery, and improves transportation of the lithium ions between positive and negative electrodes.

According to embodiments of the present disclosure, the electrolyte may include the imide-based lithium salt together with the first lithium salt.

For example, the imide-based lithium salt may be a bis sulfonyl imide-based lithium salt.

In some embodiments, the imide-based lithium salt may be one or more selected from Li(FSO₂)₂N (lithium bis(fluorosulfonyl)imide: LiFSI), and LiN(CₓF₂ₓ₊₁SO₂)(C_{y}F_{2y+1}SO₂), where x of the LiN(CₓF₂ₓ₊₁SO₂)(C_{y}F_{2y+1}SO₂) is an integer in a range from 1 to 20, and y of the LiN(CₓF₂ₓ₊₁SO₂)(C_{y}F_{2y+1}SO₂) is an integer in a range from 0 to 20.

For example, x of the LiN(CₓF₂ₓ₊₁SO₂)(C_{y}F_{2y+1}SO₂) may each independently be an integer selected from 1 to 10, and y of the LiN(CₓF₂ₓₓ₊₁SO₂)(C_{y}F_{2y+1}SO₂) may each independently be an integer selected from 0 to 10 or, for example, x may each independently be an integer selected from 1 to 4, and y may each independently be an integer selected from 0 to 4.

In an embodiment, the imide-based lithium salt may be represented by any one selected from Chemical Formulas 1A to 1D.

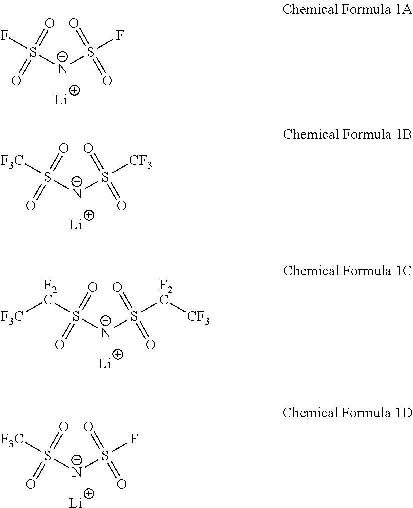

The first lithium salt and the imide-based lithium salt may be included in the electrolyte in a molar ratio of about 1:0.1 to about 1:5.

When the molar ratio of the first lithium salt to the imide-based lithium salt is within the above range, it is possible to further improve generation of gas (e.g., to further reduce gas generation) and decrease in cycle-life (e.g., to further reduce or avoid the decrease in cycle-life) under high-voltage conditions while preventing or reducing corrosion of the positive electrode current collector.

For example, the molar ratio of the first lithium salt to the imide-based lithium salt is about 1:0.2 to about 1:5, about 1:0.3 to about 1:5, about 1:0.4 to about 1:5, about 1:0.5 to about 1:5, or it may be included in a molar ratio of about 1:0.5 to about 1:4, or, for example, it may be included in a molar ratio of about 1:0.5 to about 1:2.

The content of the first lithium salt may be about 0.3 M to about 1.5 M. For example, the first lithium salt may be present in the electrolyte solution at a concentration of about 0.3 M to about 1.5 M. Herein, the content of the first lithium salt (M) refers to mole number of the first lithium salt based on 1L of the electrolyte solution.

When the content of the first lithium salt is within the above range, excellent output characteristics may be exhibited.

The first lithium salt may include one or more selected from LiPF₆, LiBF₄, lithium difluoro(oxalate)borate (LiDFOB), LiPO₂F₂, LiSbF₆, LiAsF₆, LiC₄F₉SO₃, LiClO₄, LiAlO₂, LiAlCl₄, LiCl, LiI, and LiB(C₂O₄)₂ (lithium bis(oxalato) borate: LiBOB), and, for example, the use of LiPF₆ may be suitable or desirable for forming a LiₓP_{y}O_{z} (1≤x≤4, 1≤y≤4, 0≤z≤7) film, which is beneficial for cycle-life and high-temperature characteristics, and may prevent or reduce precipitation of Ni.

A content of the imide-based lithium salt may be about 0.2 M to about 1.0 M. For example, the imide-based lithium salt may be present in the electrolyte solution at a concentration of about 0.2 M to about 1.0 M. When the content of the imide-based lithium salt is within the ranges, higher ion conductivity may be obtained than when the first lithium salt is used alone, which is expected to delay degradation of cell performance caused by decomposition products such as PF₅, HF, and/or the like generated by the LiPF₆ decomposition. Herein, the content of the imide-based lithium salt (M) refers to mole number of the imide-based lithium salt based on 1 L of the electrolyte solution.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and/or the like. The ester-based solvent may include methyl acetate, ethyl acetate, n-propyl acetate, t-butyl acetate, methyl propionate, ethyl propionate, propyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. In addition, the ketone-based solvent may include cyclohexanone, and/or the like. The alcohol-based solvent may include ethanol, isopropyl alcohol, and/or the like, and the aprotic solvent may include nitriles such as R—CN (wherein R is a hydrocarbon group having a C2 to C20 linear, branched, or cyclic structure and may include a double bond, an aromatic ring, and/or an ether bond), and/or the like, amides such as dimethyl formamide, and/or the like, dioxolanes such as 1,3-dioxolane, and/or the like, sulfolanes, and/or the like.

The non-aqueous organic solvent may be used at alone or in a mixture of two or more. When the non-aqueous organic solvent is used in a mixture, the mixing ratio may be controlled in accordance with a suitable or desirable battery performance, which should be widely understood by those skilled in the art upon review of the present disclosure.

For example, the non-aqueous organic solvent may contain less than about 5 wt % of ethylene carbonate based on the total weight of the non-aqueous organic solvent.

When the content range of ethylene carbonate is greater than or equal to about 5 wt %, an oxidation number of Ni may be more reduced from 4 to 2 due to an increased in Ni activity, when driven at a high voltage, wherein the ethylene carbonate having low oxidation stability is oxidized and decomposed, resultantly eluting Ni and thus precipitating the Ni on the negative electrode.

As an example, the non-aqueous organic solvent may be composed of only chain carbonate (e.g., the non-aqueous organic solvent may consist of chain carbonate). In this case, excellent storage characteristics at a high temperature may be realized as a resistance increase rate is significantly reduced during high-temperature storage.

In the present disclosure, the expression “composed of the chain carbonate” means that it is not mixed together with the cyclic carbonate and the like and includes a non-aqueous organic solvent belonging to the category of the chain carbonate alone or in combination.

In an embodiment, the chain carbonate may be represented by Chemical Formula 2.

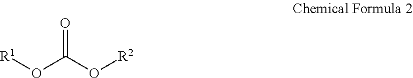

In Chemical Formula 2
R¹ and R² may each independently be a substituted or unsubstituted C1 to C20 alkyl group.

For example, R¹ and R² in Chemical Formula 2 may each independently be a substituted or unsubstituted C1 to C10 alkyl group, and for example, R¹ and R² may each independently be a substituted or unsubstituted C1 to C5 alkyl group.

In an embodiment, R¹ and R² in Chemical Formula 2 may each independently be a substituted or unsubstituted methyl group, a substituted or unsubstituted ethyl group, a substituted or unsubstituted n-propyl group, a substituted or unsubstituted n-butyl group, a substituted or unsubstituted n-pentyl group, a substituted or unsubstituted iso-butyl group, or a substituted or unsubstituted neo-pentyl group.

For example, the non-aqueous organic solvent according to an embodiment may be a mixture of two or more solvents selected from dimethyl carbonate (DMC), diethyl carbonate (DEC), dipropyl carbonate (DPC), methylpropyl carbonate (MPC), ethylpropyl carbonate (EPC), and ethylmethyl carbonate (EMC).

The non-aqueous organic solvent according to an embodiment may be a mixed solvent of dimethyl carbonate (DMC) and ethylmethyl carbonate (EMC).

The non-aqueous organic solvent may include ethylmethyl carbonate (EMC) and dimethyl carbonate (DMC) in a volume ratio of about 10:90 to about 50:50.

It may be more suitable or desirable in terms of improving battery characteristics that the non-aqueous organic solvent includes dimethyl carbonate (DMC) in an amount of greater than about 50 volume % based on the total volume of the non-aqueous organic solvent.

For example, the non-aqueous organic solvent may include ethylmethyl carbonate (EMC) and dimethyl carbonate (DMC) in a volume ratio of about 10:90 to about 40:60, or about 10:90 to about 30:70.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed together in a volume ratio of about 1:1 to about 30:1.

The aromatic hydrocarbon-based organic solvent may be an aromatic hydrocarbon-based compound represented by Chemical Formula 4.

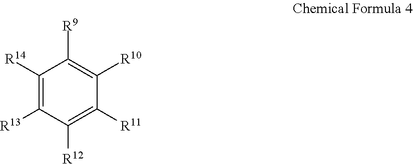

In Chemical Formula 4, R⁹ to R¹⁴ are the same or different and are selected from hydrogen, a halogen, a C1 to C10 alkyl group, a C1 to C10 haloalkyl group, and a combination thereof.

Examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

In some embodiments, the electrolyte solution further includes one or more other additives selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

By further including the other additives, cycle-life may be further improved and/or gas generated from the positive electrode and negative electrode during high-temperature storage may be effectively controlled.

The other additive may be included in an amount of about 0.2 parts by weight to about 20 parts by weight, about 0.2 parts by weight to about 15 parts by weight, or, for example, about 0.2 parts by weight to about 10 parts by weight, based on 100 parts by weight of the electrolyte solution for a rechargeable lithium battery.

When the content of the other additive is as described above the increase in film resistance may be minimized or reduced, thereby contributing to the improvement of battery performance.

The positive electrode includes a positive electrode current collector and a positive electrode active material layer formed on the positive electrode current collector, and the positive electrode active material layer includes a positive electrode active material.

The positive electrode active material may include a cobalt-free lithium nickel manganese-based oxide.

In embodiments of the present disclosure, the cobalt-free lithium nickel manganese-based oxide as a positive electrode active material means a positive electrode active material composed mainly of nickel, manganese, etc. without including cobalt in the composition of the positive electrode active material.

For example, the cobalt-free lithium nickel manganese-based oxide may include one or more selected from lithium composite oxides represented by Chemical Formula 3.

LiₐNiₓMn_{y}M¹_{z}M²_{w}O_{2±b}X_{c} Chemical Formula 3

In Chemical Formula 3,
0.5≤a<1.8, 0≤b≤0.1, 0≤c≤0.1, 0≤w<0.1, 0.6≤x<1.0, 0<y<0.4, 0<z<0.1, w+x+y+z=1,
M¹ and M² are each independently one or more element selected from Al, Mg, Ti, Zr, Cr, Sr, V, B, W, Mo, Nb, Si, Ba, Ca, Ce, Cr, Fe, and Nb, and X is one or more element selected from S, F, P, and Cl.

The lithium composite oxide may have a coating layer on the surface, or the lithium composite oxide may be mixed together with another compound having a coating layer. The coating layer may include one or more coating element compound selected from an oxide of a coating element, a hydroxide of the coating element, an oxyhydroxide of the coating element, an oxycarbonate of the coating element, and a hydroxy carbonate of the coating element. The compound for the coating layer may be amorphous or crystalline. The coating element included in the coating layer may include Mg, Al, K, Na, Ca, Si, Ti, V, Sn, Ge, Ga, B, As, Zr, or a mixture thereof. The coating process may include any suitable processes generally used in the art as long as it does not cause any undesirable side effects on the properties of the positive electrode active material (e.g., ink jet coating, dipping), and thus, further description thereof is not necessary here.

For example, the lithium composite oxide represented by Chemical Formula 3 may be represented by Chemical Formula 3-1.

LiₐNiₓ₁Mn_{y1}Al_{z1}M²_{w1}O_{2±b}X_{c} Chemical Formula 3-1

In Chemical Formula 3-1,
0.5≤a<1.8, 0≤b≤0.1, 0≤c≤0.1, 0≤w1<0.1, 0.6≤x1<1.0, 0<y1<0.4, 0<z1<0.1, w1+x1+y1+z1=1,
M² is one or more elements selected from Mg, Ti, Zr, Cr, Sr, V, B, W, Mo, Nb, Si, Ba, Ca, Ce, Cr, Fe, and Nb, and X is one or more element selected from S, F, P, and Cl.

In an embodiment, in Chemical Formula 3-1, 0.6≤x1≤0.9, 0.1≤y1<0.4, and 0<z1<0.1, or 0.6≤x1≤0.8, 0.2≤y1<0.4, and 0<z1<0.1.

For example, in Chemical Formula 3-1, x1 may be 0.6≤x1≤0.79, y1 may be 0.2≤y1≤0.39, and z1 may be 0.01≤z1<0.1.

The content of the positive electrode active material may be about 90 wt % to about 98 wt % based on the total weight of the positive electrode active material layer.

In an embodiment, the positive electrode active material layer may include a binder. The content of the binder may be about 1 wt % to about 5 wt % based on the total weight of the positive electrode active material layer.

The binder improves binding properties of positive electrode active material particles with one another and with a positive electrode current collector. Examples thereof may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The positive electrode current collector may include Al foil, but is not limited thereto.

The negative electrode includes a negative electrode current collector and a negative electrode active material layer including a negative electrode active material formed on the negative electrode current collector.

The negative electrode active material may include a material that reversibly intercalates/deintercalates lithium ions, a lithium metal, a lithium metal alloy, a material being capable of doping/dedoping lithium, and/or a transition metal oxide.

The material that reversibly intercalates/deintercalates lithium ions may include carbon materials. The carbon material may be any suitable generally-used carbon-based negative electrode active material in a rechargeable lithium battery. Examples of the carbon material include crystalline carbon, amorphous carbon, and a combination thereof. The crystalline carbon may be non-shaped, or sheet, flake, spherical, or fiber shaped natural graphite and/or artificial graphite. The amorphous carbon may be a soft carbon, a hard carbon, a mesophase pitch carbonization product, calcined coke, and/or the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, Si-C composite, SiOₓ (0<x<2), a Si-Q alloy (wherein Q is an element selected from an alkali metal, an alkaline-earth metal, a Group 13 element, a Group 14 element except Si, a Group 15 element, a Group 16 element, a transition metal, a rare earth element, and a combination thereof), Sn, SnO₂, a Sn—R alloy (wherein R is an element selected from an alkali metal, an alkaline-earth metal, a Group 13 element, a Group 14 element except Sn, a Group 15 element, a Group 16 element, a transition metal, a rare earth element, and a combination thereof), and/or the like. One or more these materials may be mixed together with SiO₂.

The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The transition metal oxide may be a vanadium oxide, a lithium vanadium oxide, and/or the like.

In an example embodiment, the negative electrode active material may include graphite, a Si composite or a mixture thereof.

The Si composite may include a core including Si-based particles and an amorphous carbon coating layer. For example, the Si-based particles may include one or more selected from silicon particles, a Si—C composite, SiOₓ (0<x≤2), and a Si alloy.

For example, voids may be included in the central portion of the core including the Si-based particles, a radius of the central portion may correspond to about 30% to about 50% of the radius of the Si composite, an average particle diameter of the Si composite may be about 5 μm to about 20 μm, and an average particle diameter of the Si-based particles may be about 10 nm to about 200 nm.

In the present specification, an average particle diameter (D50) may be a particle size at a volume ratio of 50% in a cumulative size-distribution curve.

When the average particle diameter of the Si-based particles is within the above ranges, volume expansion occurring during charging and discharging may be suppressed or reduced, and interruption of a conductive path due to particle crushing during charging and discharging may be prevented or reduced.

The core including the Si-based particles may further include amorphous carbon, and at this time, the central portion may not include amorphous carbon, and the amorphous carbon may exist only in the surface portion of the Si composite.

Herein, the surface portion means a region from the outermost surface of the central portion to the outermost surface of the Si composite.

In addition, the Si-based particles are substantially uniformly included throughout the Si composite, for example, may be present in a substantially uniform concentration in the central portion and surface portion.

The amorphous carbon may be soft carbon, hard carbon, a mesophase pitch carbonization product, calcined coke, or a combination thereof.

For example, the Si—C composite may include silicon particles and crystalline carbon.

The silicon particles may be included in an amount of about 1 wt % to about 60 wt %, for example, about 3 wt % to about 60 wt %, based on the total weight of the Si—C composite.

The crystalline carbon may be, for example, graphite, and, for example, natural graphite, artificial graphite, or a combination thereof.

An average particle diameter of the crystalline carbon may be about 5 μm to about 30 μm.

When the negative electrode active material includes the graphite and Si composite together, the graphite and Si composite may be included in the form of a mixture, and the graphite and Si composite may be included in a weight ratio of about 99:1 to about 50:50.

In some embodiments, the graphite and Si composite may be included in a weight ratio of about 97:3 to about 80:20, or about 95:5 to about 80:20.

The amorphous carbon precursor may be coal-based pitch, mesophase pitch, petroleum-based pitch, coal-based oil, petroleum-based heavy oil, and/or a polymer resin such as a phenol resin, a furan resin, and/or a polyimide resin.

In the negative electrode active material layer, the negative electrode active material may be included in an amount of about 95 wt % to about 99 wt % based on the total weight of the negative electrode active material layer.

In an embodiment, the negative electrode active material layer may further include a binder, and optionally a conductive material (e.g., an electrically conductive material). The content of the binder in the negative electrode active material layer may be about 1 wt % to about 5 wt % based on the total weight of the negative electrode active material layer. In the negative electrode active material layer, the amount of the conductive material binder may be about 1 wt % to about 5 wt % based on the total weight of the negative electrode active material layer.

The binder improves binding properties of negative electrode active material particles with one another and with a negative electrode current collector. The binder may be a non-water-soluble binder, a water-soluble binder, or a combination thereof.

The non-water-soluble binder may be polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder and/or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropylene copolymer, polyethylene oxide, polyvinylpyrrolidone, polyepichlorohydrine, polyphosphazene, polyacrylonitrile, polystyrene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof.

When the water-soluble binder is used as a negative electrode binder, a cellulose-based compound may be further used to provide viscosity as a thickener. The cellulose-based compound includes one or more of carboxymethyl cellulose, hydroxypropylmethyl cellulose, methyl cellulose, and alkali metal salts thereof. The alkali metals may be Na, K, and/or Li. Such a thickener may be included in an amount of about 0.1 to about 3 parts by weight based on 100 parts by weight of the negative electrode active material.

The conductive material is included to provide electrode conductivity (e.g., electrical conductivity) and any suitable electrically conductive material may be used as a conductive material unless it causes an undesirable chemical change in the rechargeable lithium battery. Examples of the conductive material may include a carbon-based material such as natural graphite, artificial graphite, carbon black, acetylene black, ketjen black, a carbon fiber, and the like; a metal-based material including a metal powder and/or a metal fiber of copper, nickel, aluminum silver, and/or the like; a conductive polymer such as a polyphenylene derivative; or a mixture thereof.

The negative electrode current collector may be selected from a copper foil, a nickel foil, a stainless steel foil, a titanium foil, a nickel foam, a copper foam, a polymer substrate coated with a conductive metal (e.g., an electrically conductive metal), and a combination thereof.

The rechargeable lithium battery may further include a separator between the negative electrode and the positive electrode, depending on a type (or kind) of the battery. Examples of a suitable separator material include polyethylene, polypropylene, polyvinylidene fluoride, and multi-layers thereof such as a polyethylene/polypropylene double-layered separator, a polyethylene/polypropylene/polyethylene triple-layered separator, and/or a polypropylene/polyethylene/polypropylene triple-layered separator.

The rechargeable lithium battery may have a charging upper limit voltage of greater than or equal to about 4.45 V. For example, the charging upper limit voltage may be about 4.45 V to about 4.55 V.

Hereinafter, examples of the present disclosure and comparative examples are described. These examples, however, are not in any sense to be interpreted as limiting the scope of the present disclosure.

### MANUFACTURE OF RECHARGEABLE LITHIUM BATTERY CELL

### Comparative Example 1

LiNi_{0.75}Mn_{0.23}Al_{0.02}O₂ as a positive electrode active material, polyvinylidene fluoride as a binder, and acetylene black as a conductive material were mixed together in a weight ratio of 96:3:1 and then, dispersed in N-methyl pyrrolidone, thereby preparing positive electrode active material slurry.

The positive electrode active material slurry was coated on a 15 μm-thick Al foil, dried at 100° C., and pressed, thereby manufacturing a positive electrode.

A negative electrode active material slurry was also prepared by using a mixture of artificial graphite and Si composite in a weight ratio of 93:7 as a negative electrode active material and then, mixing together the negative electrode active material, a styrene-butadiene rubber binder, and carboxylmethyl cellulose in a weight ratio of 98:1:1 and dispersing the obtained mixture in distilled water.

As for the Si composite, a core including artificial graphite and silicon particles was coated with coal-based pitch on the surface.

The negative electrode active material slurry was coated on a 10 μm thick Cu foil, dried at 100° C., and pressed, thereby manufacturing a negative electrode.

The manufactured positive and negative electrodes were assembled with a 10 μm thick polyethylene separator to manufacture an electrode assembly, and an electrolyte solution was injected thereinto, thereby manufacturing a rechargeable lithium battery cell.

The electrolyte solution had a composition as follows.

### Composition of Electrolyte Solution

A lithium salt: 1.5 M LiPF₆

Non-aqueous organic solvent: ethylmethyl carbonate:dimethyl carbonate (EMC:DMC=a volume ratio of 20:80)

### Example 1

A rechargeable lithium battery cell was manufactured in substantially the same manner as in Comparative Example 1, except that the content of the lithium salt was changed to 0.75 M LiPF₆ and 0.75 M LiFSI (the first lithium salt and the imide-based lithium salt, respectively).

### Example 2

A rechargeable lithium battery cell was manufactured in substantially the same manner as in Comparative Example 1, except that the content of the lithium salt was changed to 0.75 M LiPF₆ and 0.75 M LiTFSI represented by Chemical Formula 1B (the first lithium salt and the imide-based lithium salt, respectively).

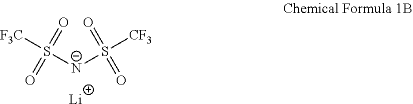 [SMILES: O=S(=O)([N-]S(=O)(=O)C(F)(F)F)C(F)(F)F ; [Li+]]

### Example 3

A rechargeable lithium battery cell was manufactured in substantially the same manner as in Comparative Example 1, except that the content of the lithium salt was changed to 0.75 M LiPF₆ and 0.75 M LiTFTSI represented by Chemical Formula 1D (the first lithium salt and the imide-based lithium salt, respectively).

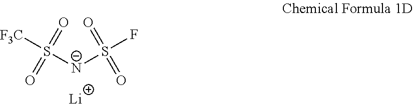 [SMILES: O=S(=O)(F)[N-]S(=O)(=O)C(F)(F)F ; [Li+]]

### Example 4

A rechargeable lithium battery cell was manufactured in substantially the same manner as in Example 1, except that the content of the lithium salt was changed 1 to 1.0 M LiPF₆ and 0.5 M LiFSI (the first lithium salt and the imide-based lithium salt, respectively).

### Example 5

A rechargeable lithium battery cell was manufactured in substantially the same manner as in Example 1, except that the content of the lithium salt was changed to 0.5 M LiPF₆ and 1.0 M LiFSI (the first lithium salt and the imide-based lithium salt, respectively).

### Example 6

A rechargeable lithium battery cell was manufactured in substantially the same manner as in Example 1, except that the composition of the non-aqueous organic solvent was changed to a volume ratio of EMC:DMC=30:70.

### Comparative Example 2

A rechargeable lithium battery cell was manufactured in substantially the same manner as in Comparative Example 1, except that the lithium salt (the first lithium salt and the imide-based lithium salt) was changed to LiFSI 1.5 M.

### Comparative Example 3

A rechargeable lithium battery cell was manufactured in substantially the same manner as in Example 1, except that 5 wt % of ethylene carbonate was added based on the total weight of the non-aqueous organic solvent in the composition of the electrolyte solution.

### Comparative Example 4

A rechargeable lithium battery cell was manufactured in substantially the same manner as in Comparative Example 3, except that 10 wt % of ethylene carbonate was added.

### Example 7

A rechargeable lithium battery cell was manufactured in substantially the same manner as in Example 1, except that the composition of the non-aqueous organic solvent was changed to a volume ratio of EMC:DMC=40:60.

### Example 8

A rechargeable lithium battery cell was manufactured in substantially the same manner as in Comparative Example 1, except that the composition of the non-aqueous organic solvent was changed to a volume ratio of EMC:DMC=60:40.

### Comparative Example 5

A rechargeable lithium battery cell was manufactured in substantially the same manner as in Example 1, except that the positive electrode active material was changed to LiNi_{0.8}Co_{0.1}Mn_{0.1}O₂.

### Comparative Example 6

A rechargeable lithium battery cell was manufactured in substantially the same manner as in Comparative Example 1, except that 10 wt % of fluoroethylene carbonate was added.

### Evaluation 1: Evaluation of Room-Temperature Cycle-Life Characteristics and Direct Current Internal Resistance (DC-IR) Increase Rate

The rechargeable lithium battery cells according to Examples 1 to 8 and Comparative Examples 1 to 6 were charged and discharged under the following conditions and then, evaluated with respect to cycle-life characteristics, and the results are shown in Tables 1 to 6.

While 200 cycles charged and discharged under the conditions of charging at 0.33 C (CC/CV, 4.45 V, 0.025 C Cut-off)/discharging at 1.0 C (CC, 2.5 V Cut-off) at 25° C., the rechargeable lithium battery cells were measured with respect to changes in discharge capacity and direct current internal resistance.

A ratio of discharge capacity after the 200 cycles to initial discharge capacity was calculated, that is capacity retention@25° C., 200 cycle, and the results are shown in Table 1.

The cells were measured with respect to initial direct current internal resistance (DCIR) by using ΔV/ΔI (voltage change/current change) and then, to a change in the direct current internal resistance (DC-IR) by setting a maximum energy state of the rechargeable lithium battery cells at 50% state of charge (SOC 50%), applying a current of 0.5 C thereto, and inserting a voltage changed during the discharge into Ohm's law (ΔV/ΔI).

An increase rate of the direct current internal resistance was calculated according to the following equation.

[{(DC-IR after 200 cycles)/(Initial DC-IR)}*100%]

### Evaluation 2: Evaluation of High-Temperature Cycle-Life Characteristics and Direct Current Internal Resistance (DC-IR) Increase Rate

The rechargeable lithium battery cells according to Examples 1 to 8 and Comparative Examples 1 to 6 were charged and discharged under the following conditions and then, evaluated with respect to cycle-life characteristics, and the results are shown in Tables 7 to 12.

While 200 cycles charged and discharged under the conditions of charging at 0.33 C (CC/CV, 4.45 V, 0.025 C Cut-off)/discharging at 1.0 C (CC, 2.5 V Cut-off) at 45° C., the rechargeable lithium battery cells were measured with respect to changes in discharge capacity and direct current internal resistance.

A ratio of the discharge capacity after the 200 cycles to the initial discharge capacity that is capacity retention@45° C., 200 cycle, is shown in Table 7.

The rechargeable lithium battery cells were measured with respect to initial direct current internal resistance (DC-IR) by using ΔV/ΔI (voltage change/current change) and then, to a change in the direct current internal resistance (DC-IR) by setting a maximum energy state of the rechargeable lithium battery cells at 50% state of charge (SOC 50%), applying a current of 0.5 C thereto, and inserting a voltage changed during the discharge into Ohm's law (ΔV/ΔI).

An increase rate of the direct current internal resistance was calculated according to the following equation.

[{(DC-IR after 200 cycles)/(Initial DC-IR)}*100%]

### Evaluation 3: Evaluation of Metal (Ni and Mn) Elution

The rechargeable lithium battery cells according to Examples 1 to 8 and Comparative Examples 1 to 6 were measured with respect to elution amounts of Ni and Mn according to the following method.

The rechargeable lithium battery cells, which were 200 cycles charged and discharged according to Evaluations 1 and 2, were disassembled to separate positive electrode plates. The contents of Ni and Mn were measured through an inductively coupled plasma mass spectrometry (ICP-MS) analysis, and the results are shown in Tables 1 to 12.

TABLE 1

| | | | | DC-IR | | |
|---|---|---|---|---|---|---|
| | Capacity | | | Increase | | |
| | retention | | | rate | Ni | Mn |
| | @25° C., | Initial | DC-IR | (25° C., | detected | detected |
| | 200 | DC-IR | after | 200 | amount | amount |
| | cycle | @25° C. | 200 cy | cycle) | @25° C. | @25° C. |
| | (%) | (mΩ) | (mΩ) | (%) | (ppm) | (ppm) |
| Comparative | 56.4 | 43.1 | 101.8 | 233 | 1734 | 187 |
| Example 1 | | | | | | |
| Example 1 | 73.1 | 43.9 | 59.3 | 135 | 294 | 81 |
| Example 2 | 68.9 | 44.0 | 67.8 | 154 | 412 | 94 |
| Example 3 | 67.7 | 44.3 | 66.9 | 151 | 447 | 93 |

TABLE 2

| | | | | DC-IR | | |
|---|---|---|---|---|---|---|
| | Capacity | | | Increase | | |
| | retention | | | rate | Ni | Mn |
| | @25° C., | Initial | DC-IR | (25° C., | detected | detected |
| | 200 | DC-IR | after | 200 | amount | amount |
| | cycle | @25° C. | 200 cy | cycle) | @25° C. | @25° C. |
| | (%) | (mΩ) | (mΩ) | (%) | (ppm) | (ppm) |
| Comparative | 56.4 | 43.1 | 101.8 | 233 | 1734 | 187 |
| Example 1 | | | | | | |
| Comparative | 41.1 | 48.0 | 181 | 377 | 3430 | 251 |
| Example 2 | | | | | | |
| Example 1 | 73.1 | 43.9 | 59.3 | 135 | 294 | 81 |
| Example 4 | 72.5 | 43.5 | 61.3 | 141 | 291 | 80 |
| Example 5 | 72.2 | 44.0 | 60.7 | 138 | 285 | 77 |

TABLE 3

| | | | | DC-IR | | |
|---|---|---|---|---|---|---|
| | Capacity | | | Increase | | |
| | retention | | | rate | Ni | Mn |
| | @25° C., | Initial | DC-IR | (25° C., | detected | detected |
| | 200 | DC-IR | after | 200 | amount | amount |
| | cycle | @25° C. | 200 cy | cycle) | @25° C. | @25° C. |
| | (%) | (mΩ) | (mΩ) | (%) | (ppm) | (ppm) |
| Comparative | 40.3 | 45.5 | 206.6 | 454 | 1924 | 217 |
| Example 3 | | | | | | |
| Comparative | 33.7 | 46.2 | 243.5 | 527 | 2384 | 397 |
| Example 4 | | | | | | |
| Example 1 | 73.1 | 43.9 | 59.3 | 135 | 294 | 81 |

TABLE 4

| | | | | DC-IR | | |
|---|---|---|---|---|---|---|
| | Capacity | | | Increase | | |
| | retention | | DC-IR | rate | Ni | Mn |
| | @25° C., | Initial | after | (25° C., | detected | detected |
| | 200 | DC-IR | 200 | 200 | amount | amount |
| | cycle | @25° C. | cycle | cycle) | @25° C. | @25° C. |
| | (%) | (mΩ) | (mΩ) | (%) | (ppm) | (ppm) |
| Example 1 | 73.1 | 43.9 | 59.3 | 135 | 294 | 81 |
| Example 6 | 70.0 | 46.0 | 62.1 | 135 | 320 | 97 |
| Example 7 | 62.5 | 44.2 | 65.7 | 149 | 612 | 150 |
| Example 8 | 56.7 | 46.7 | 77.4 | 166 | 1237 | 180 |
| Comparative | 56.4 | 43.1 | 101.8 | 233 | 1734 | 187 |
| Example 1 | | | | | | |

TABLE 5

| | | | | DC-IR | | |
|---|---|---|---|---|---|---|
| | Capacity | | | Increase | | |
| | retention | | DC-IR | rate | Ni | Mn |
| | @25° C., | Initial | after | (25° C., | detected | detected |
| | 200 | DC-IR | 200 | 200 | amount | amount |
| | cycle | @25° C. | cycle | cycle) | @25° C. | @25° C. |
| | (%) | (mΩ) | (mΩ) | (%) | (ppm) | (ppm) |
| Example 1 | 73.1 | 43.9 | 59.3 | 135 | 294 | 81 |
| Example 2 | 68.9 | 44.0 | 67.8 | 154 | 412 | 94 |
| Example 3 | 67.7 | 44.3 | 66.9 | 151 | 447 | 93 |
| Comparative | 60.6 | 49.7 | 88.7 | 178 | 1237 | 199 |
| Example 5 | | | | | | |

TABLE 6

| | | | | DC-IR | | |
|---|---|---|---|---|---|---|
| | Capacity | | | Increase | | |
| | retention | | DC-IR | rate | Ni | Mn |
| | @25° C., | Initial | after | (25° C., | detected | detected |
| | 200 | DC-IR | 200 | 200 | amount | amount |
| | cycle | @25° C. | cycle | cycle) | @25° C. | @25° C. |
| | (%) | (mΩ) | (mΩ) | (%) | (ppm) | (ppm) |
| Example 1 | 73.1 | 43.9 | 59.3 | 135 | 294 | 81 |
| Example 2 | 68.9 | 44.0 | 67.8 | 154 | 412 | 94 |
| Example 3 | 67.7 | 44.3 | 66.9 | 151 | 447 | 93 |
| Comparative | unmeas- | 57.2 | unmeas- | unmeas- | 3571 | 558 |
| Example 6 | urable | | urable | urable | | |

TABLE 7

| | | | | DC-IR | | |
|---|---|---|---|---|---|---|
| | Capacity | | | Increase | | |
| | retention | | DC-IR | rate | Ni | Mn |
| | @45° C., | Initial | after | (45° C., | detected | detected |
| | 200 | DC-IR | 200 | 200 | amount | amount |
| | cycle | @45° C. | cycle | cycle) | @45° C. | @45° C. |
| | (%) | (mΩ) | (mΩ) | (%) | (ppm) | (ppm) |
| Comparative | 41.3 | 43.0 | 117.1 | 272 | 2193 | 225 |
| Example 1 | | | | | | |
| Example 1 | 69.9 | 43.7 | 67.3 | 154 | 313 | 93 |
| Example 2 | 65.1 | 43.8 | 71.8 | 164 | 337 | 101 |
| Example 3 | 64.4 | 44.1 | 66.9 | 176 | 357 | 108 |

TABLE 8

| | | | | DC-IR | | |
|---|---|---|---|---|---|---|
| | Capacity | | | Increase | | |
| | retention | | DC-IR | rate | Ni | Mn |
| | @45° C., | Initial | after | (45° C., | detected | detected |
| | 200 | DC-IR | 200 | 200 | amount | amount |
| | cycle | @45° C. | cy | cycle) | @45° C. | @45° C. |
| | (%) | (mΩ) | (mΩ) | (%) | (ppm) | (ppm) |
| Comparative | 41.3 | 43.0 | 117.1 | 272 | 2193 | 225 |
| Example 1 | | | | | | |
| Comparative | 20.4 | 48.2 | 275.2 | 571 | 4254 | 351 |
| Example 2 | | | | | | |
| Example 1 | 69.9 | 43.7 | 67.3 | 154 | 313 | 93 |
| Example 4 | 68.7 | 44.0 | 70.4 | 160 | 301 | 89 |
| Example 5 | 69.0 | 43.6 | 67.6 | 155 | 310 | 99 |

TABLE 9

| | | | | DC-IR | | |
|---|---|---|---|---|---|---|
| | Capacity | | | Increase | | |
| | retention | | DC-IR | rate | Ni | Mn |
| | @45° C., | Initial | after | (45° C., | detected | detected |
| | 200 | DC-IR | 200 | 200 | amount | amount |
| | cycle | @45° C. | cycle | cycle) | @45° C. | @45° C. |
| | (%) | (mΩ) | (mΩ) | (%) | (ppm) | (ppm) |
| Comparative | 22.4 | 45.3 | 348.1 | 768 | 2121 | 254 |
| Example 3 | | | | | | |
| Comparative | 13.4 | 45.8 | 441.2 | 963 | 2513 | 414 |
| Example 4 | | | | | | |
| Example 1 | 69.9 | 43.7 | 67.3 | 154 | 313 | 93 |

TABLE 10

| | | | | DC-IR | | |
|---|---|---|---|---|---|---|
| | Capacity | | | Increase | | |
| | retention | | DC-IR | rate | Ni | Mn |
| | @45° C., | Initial | after | (45° C., | detected | detected |
| | 200 | DC-IR | 200 | 200 | amount | amount |
| | cycle | @45° C. | cy | cycle) | @45° C. | @45° C. |
| | (%) | (mΩ) | (mΩ) | (%) | (ppm) | (ppm) |
| Example 1 | 69.9 | 43.7 | 67.3 | 154 | 313 | 93 |
| Example 6 | 64.6 | 46.6 | 71.8 | 154 | 420 | 152 |
| Example 7 | 58.5 | 44.3 | 75.1 | 170 | 814 | 187 |
| Example 8 | 51.0 | 46.8 | 82.7 | 177 | 1887 | 303 |
| Comparative | 41.3 | 43.0 | 117.1 | 272 | 2193 | 225 |
| Example 1 | | | | | | |

TABLE 11

| | | | | DC-IR | | |
|---|---|---|---|---|---|---|
| | Capacity | | | Increase | | |
| | retention | | DC-IR | rate | Ni | Mn |
| | @45° C., | Initial | after | (45° C., | detected | detected |
| | 200 | DC-IR | 200 | 200 | amount | amount |
| | cycle | @45° C. | cy | cycle) | @45° C. | @45° C. |
| | (%) | (mΩ) | (mΩ) | (%) | (ppm) | (ppm) |
| Example 1 | 69.9 | 43.7 | 67.3 | 154 | 313 | 93 |
| Example 2 | 65.1 | 43.8 | 71.8 | 164 | 337 | 101 |
| Example 3 | 64.4 | 44.1 | 66.9 | 176 | 357 | 108 |
| Comparative | 58.0 | 49.7 | 77.1 | 155 | 1725 | 247 |
| Example 5 | | | | | | |

TABLE 12

| | | | | DC-IR | | |
|---|---|---|---|---|---|---|
| | Capacity | | | Increase | | |
| | retention | | DC-IR | rate | Ni | Mn |
| | @45° C., | Initial | after | (45° C., | detected | detected |
| | 200 | DC-IR | 200 | 200 | amount | amount |
| | cycle | @45° C. | cy | cycle) | @45° C. | @45° C. |
| | (%) | (mΩ) | (mΩ) | (%) | (ppm) | (ppm) |
| Example 1 | 69.9 | 43.7 | 67.3 | 154 | 313 | 93 |
| Example 2 | 65.1 | 43.8 | 71.8 | 164 | 337 | 101 |
| Example 3 | 64.4 | 44.1 | 66.9 | 176 | 357 | 108 |
| Comparative | unmeas- | 57.7 | unmeas- | unmeas- | 4014 | 610 |
| Example 6 | urable | | urable | urable | | |

Referring to Tables 1, 2, 7, and 8, among the compositions of a lithium salt, a non-aqueous organic solvent, and a Co-free positive electrode active material according to embodiments of the present disclosure, a combination of including the lithium salt (the first lithium salt and the imide-based lithium salt) exhibited all improved room temperature charge and discharge characteristics and high-temperature charge and discharge characteristics, and because the increase rate of DC-IR was reduced, room temperature cycle-life characteristics and simultaneously, high-temperature cycle-life characteristics were all improved.

Referring to Tables 3 and 9, when greater than or equal to 5 wt % of EC was added to the composition of a lithium salt, a non-aqueous organic solvent, and a Co-free positive electrode active material according to the present application, the room temperature charge and discharge characteristics and the high-temperature charge and discharge characteristics were all deteriorated, and because the increase rate of DC-IR was increased, both of the room temperature cycle-life characteristics and the high-temperature cycle-life characteristics were all deteriorated.

Referring to Tables 4 and 10, among the compositions of a lithium salt, a non-aqueous organic solvent, and a Co-free positive electrode active material, for example, a combination of including the non-aqueous organic solvent according to the present application all exhibited improved room temperature charge and discharge characteristics and high-temperature charge and discharge characteristics, and because the increase rate of DC-IR was reduced, the room temperature cycle-life characteristics and simultaneously, the high-temperature cycle-life characteristics were also improved. Herein, when 50 volume % or less of EMC was included, the performances were further improved.

Referring to Tables 5 and 11, among the compositions of a lithium salt, a non-aqueous organic solvent, and a Co-free positive electrode active material according to the present application, for example, a combination of using the Co-free positive electrode active material as a positive electrode active material all exhibited improved room temperature charge and discharge characteristics and high-temperature charge and discharge characteristics, compared with when a Co-containing positive electrode active material was used, and because the increase rate of DC-IR was reduced, the room-temperature cycle-life characteristics and simultaneously, the high-temperature cycle-life characteristics were also improved.

Referring to Tables 6 and 12, the composition of a lithium salt, a non-aqueous organic solvent, and a Co-free positive electrode active material according to the present application exhibited all improved room temperature charge and discharge characteristics and high-temperature charge and discharge characteristics, compared with a composition of including an existing negative electrode film-forming agent, and because the increase rate of DC-IR was reduced, the room temperature cycle-life characteristics and simultaneously, the high-temperature cycle-life characteristics were improved.

In addition, the rechargeable lithium battery cells according to Examples 1 to 8 exhibited very low elution amounts of nickel (Ni) and manganese (Mn) from the electrode plates, but the rechargeable lithium battery cells of Comparative Examples 1 to 6 exhibited significantly larger elution amounts of Ni and Mn. Accordingly, the rechargeable lithium battery cells according to the present disclosure reduced elution amounts of metal ions by a reaction with an electrolyte solution.

While the subject matter of this disclosure has been described in connection with what is presently considered to be practical example embodiments, it is to be understood that the present disclosure is not limited to the disclosed embodiments, but, on the contrary, is intended to cover various modifications and equivalent arrangements included within the spirit and scope of the appended claims, and equivalents thereof.

### DESCRIPTION OF SYMBOLS

100: rechargeable lithium battery
112: negative electrode
113: separator
114: positive electrode
120: battery case
140: sealing member

What is claimed is:

1. A rechargeable lithium battery, comprising:
an electrolyte solution comprising a non-aqueous organic solvent, a first lithium salt, and an imide-based lithium salt;
a positive electrode comprising a positive electrode active material; and
a negative electrode comprising a negative electrode active material,
wherein the non-aqueous organic solvent contains less than about 5 wt % of ethylene carbonate based on the total weight of the non-aqueous organic solvent, and
the positive electrode active material comprises a cobalt-free lithium nickel manganese-based oxide.

2. The rechargeable lithium battery of claim 1, wherein:
the imide-based lithium salt is a bis sulfonyl imide-based lithium salt.

3. The rechargeable lithium battery of claim 1, wherein:
The imide-based lithium salt is one or more selected from Li(FSO₂)₂N (lithium bis(fluorosulfonyl)imide: LiFSI), and LiN(CₓF₂ₓ₊₁SO₂)(C_{y}F_{2y+1}SO₂), where x is an integer in a range from 1 to 20, and y is an integer in a range from 0 to 20.

4. The rechargeable lithium battery of claim 3, wherein:
the imide-based lithium salt is represented by any one selected from Chemical Formula 1A to Chemical Formula 1D:

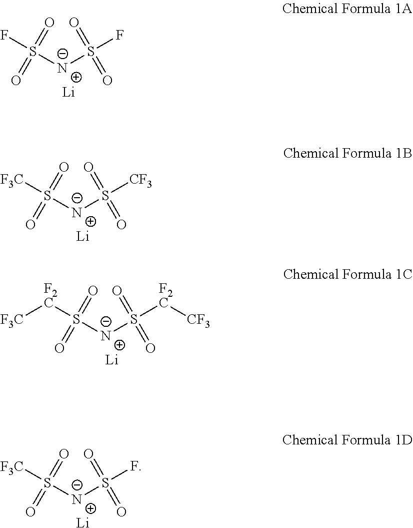

5. The rechargeable lithium battery of claim 1, wherein:
the first lithium salt and the imide-based lithium salt are included in a molar ratio of about 1:0.1 to about 1:5.

6. The rechargeable lithium battery of claim 1, wherein:
the first lithium salt and the imide-based lithium salt are included in a molar ratio of about 1:0.5 to about 1:2.

7. The rechargeable lithium battery of claim 1, wherein:
a content of the first lithium salt is about 0.3 M to about 1.5 M.

8. The rechargeable lithium battery of claim 1, wherein:
a content of the imide-based lithium salt is about 0.2 M to about 1.0 M.

9. The rechargeable lithium battery of claim 1, wherein:
the first lithium salt comprises one or more selected from LiPF₆, LiBF₄, lithium difluoro(oxalato)borate (LiDFOB), LiPO₂F₂, LiSbF₆, LiAsF₆, LiC₄F₉SO₃, LiClO₄, LiAlO₂, LiAlCl₄, LiCl, LiI, and LiB(C₂O₄)₂ (lithium bis(oxalato) borate: LiBOB).

10. The rechargeable lithium battery of claim 1, wherein:
the first lithium salt is LiPF₆.

11. The rechargeable lithium battery of claim 1, wherein
the non-aqueous organic solvent is composed of chain carbonate alone.

12. The rechargeable lithium battery of claim 11, wherein:
the chain carbonate is represented by Chemical Formula 2: 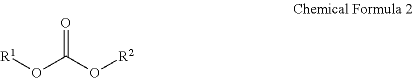
wherein, in Chemical Formula 2
R¹ and R² are each independently a substituted or unsubstituted C1 to C20 alkyl group.

13. The rechargeable lithium battery of claim 1, wherein:
the non-aqueous organic solvent is a mixture of two or more solvents selected from dimethyl carbonate (DMC), diethyl carbonate (DEC), dipropyl carbonate (DPC), methylpropyl carbonate (MPC), ethylpropyl carbonate (EPC), and ethylmethyl carbonate (EMC).

14. The rechargeable lithium battery of claim 1, wherein:
the non-aqueous organic solvent comprises ethylmethyl carbonate (EMC) and dimethyl carbonate (DMC) in a volume ratio of about 10:90 to about 50:50.

15. The rechargeable lithium battery of claim 1, wherein:
The electrolyte solution further comprises one or more other additives selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluorobiphenyl (2-FBP).

16. The rechargeable lithium battery of claim 1, wherein:
the cobalt-free lithium nickel manganese-based oxide comprises a lithium composite oxide represented by Chemical Formula 3:
LiₐNiₓMn_{y}M¹_{z}M²_{w}O_{2±b}X_{c} Chemical Formula 3
wherein, in Chemical Formula 3,
0.5≤a<1.8, 0≤b≤0.1, 0≤c≤0.1, 0≤w<0.1, 0.6≤x<1.0, 0<y<0.4, 0<z<0.1, w+x+y+z=1,
M¹ and M² are each independently one or more elements selected from Al, Mg, Ti, Zr, Cr, Sr, V, B, W, Mo, Nb, Si, Ba, Ca, Ce, Cr, Fe, and Nb, and X is one or more elements selected from S, F, P, and Cl.

17. The rechargeable lithium battery of claim 16, wherein:
the lithium composite oxide represented by Chemical Formula 3 is represented by Chemical Formula 3-1:
LiₐNiₓ₁Mn_{y1}Al_{z1}M²_{w1}O_{2±b}X_{c} Chemical Formula 3-1
wherein, in Chemical Formula 3-1,
0.5≤a<1.8, 0≤b≤0.1, 0≤c≤0.1, 0<w1≤0.1, 0.6x1<1.0, 0<y1<0.4, 0<z1<0.1, w1+x1+y1+z1=1,
M² is one or more elements selected from Mg, Ti, Zr, Cr, Sr, V, B, W, Mo, Nb, Si, Ba, Ca, Ce, Cr, Fe, and Nb, and X is one or more element selected from S, F, P, and Cl.

18. The rechargeable lithium battery of claim 17, wherein:
in Chemical Formula 3-1, x1 is 0.6≤x1≤0.79, y1 is 0.2≤y1≤0.39, and z1 is 0.01≤z1<0.1.

19. The rechargeable lithium battery of claim 1, wherein:
the negative electrode active material comprises graphite, a Si composite or a mixture thereof.

20. The rechargeable lithium battery of claim 1, wherein the rechargeable lithium battery has a charging upper limit voltage of greater than or equal to about 4.45 V.
